(19) United States
(12) Patent Application Publication
(10) Pub. No.: US 2009/0090774 A1
(43) Pub. Date: Apr. 9, 2009

(54) Printer and issuing apparatus

(76) Inventor: Akihiko Ito, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/286,867

(22) Filed: Oct. 2, 2008

(30) Foreign Application Priority Data
Oct. 4, 2007 (JP) 2007-261106

(51) Int. Cl. B65H 29/20; G06K 15/02

(52) U.S. Cl. 235/383; 271/278; 271/306

(57) ABSTRACT

In order to provide a printer and an issuing apparatus for effectively preventing a user from mistakenly inserting a card into a discharge port of tickets or the like without increasing the number of components, in the printer or the issuing apparatus having the printer built-in, an outlet of a discharge port (14a) for discharging a printed sheet is formed into a shape other than a linear shape, such as a corrugated shape or a “dogleg” shape when seen from a front thereof. Further, it is desirable that the discharge port be formed to be gradually reduced in opening area from an inlet side thereof to an outlet side thereof.

### BACKGROUND OF THE INVENTION

1. Field of the Invention

The present invention relates to a technology effectively used for a printer for performing printing on a roll sheet to issue receipts, tickets, or the like, or for an issuing apparatus having the same built-in, and more particularly, to a technology effectively used for a structure of a discharge portion for discharging the printed sheet.

2. Description of the Related Art

Conventionally, as an issuing apparatus in which a built-in printer performs printing on a roll sheet to issue receipts, tickets, or the like, there are provided a railway ticket vending machine at the station, a cash register in the store, and the like. In those issuing apparatuses, a roll sheet accommodated in a predetermined accommodating portion is drawn out, a desired printing is performed thereon by a thermal printer or the like, and thereafter, a printed sheet is cut to a desired length to be discharged.

On the front surface of the apparatus as described above which has a printer built-in, there is provided a discharge port for discharging a printed sheet. Conventionally, the shape of the discharge port is a laterally elongated rectangle or a linear slit (refer to FIG. 7 of Patent Document JP 10-119375 A, for example).

In recent years, in order to allow the purchase by using a credit card or a prepaid card, ticket issuing machines or the like having card readers built-in are on the increase. On the front surface panel of the apparatus having a card reader together with a printer, there is provided an insertion/discharge port for inserting a card in addition to a discharge port for discharging a printed sheet, the discharge port of tickets or the like and the insertion/discharge port of a card having the similar size in many cases.

Therefore, a user mistakenly inserts a card into the discharge port of tickets or the like in some cases, and hence the components inside the discharge port are damaged, which may cause a failure thereof and a trouble such as a jam caused by a printed sheet. Conventionally, in the issuing apparatus as described above, a shutter has been provided at the discharge port of tickets or the like so as to prevent a user from mistakenly inserting a card. However, the provision of the shutter at the discharge port leads to increase in the number of components, and hence upsizing of the apparatus is involved, which may cause an additional trouble that the operation of the apparatus is stopped owing to the failure of the shutter mechanism.

### SUMMARY OF THE INVENTION

It is an object of the present invention to provide a printer and an issuing apparatus for effectively preventing a user from mistakenly inserting a card into the discharge port of tickets or the like without increasing the number of components.

In order to achieve the above-mentioned object, the present invention provides a printer or an issuing apparatus having the printer built-in, in which an outlet of a discharge port for discharging a printed sheet is formed into a shape other than a linear shape, such as a corrugated shape or a “dogleg” shape when seen from a front thereof.

More specifically, in a printer including: an accommodating portion for accommodating a pre-printed sheet; a printing means for printing on the sheet drawn out of the accommodating portion; a cutting means for cutting a printed sheet to a desired length; and a discharge port for discharging a cut sheet to an exterior of an apparatus, an outlet of the discharge port is formed into a shape other than a linear shape when seen from a front thereof.

In the above-mentioned means, since the outlet of the discharge port is not a linear shape, the printed sheet of low elasticity can easily pass the discharge port. Meanwhile, it is difficult for a card of relatively high elasticity to pass the discharge port, and hence insertion of the card from the exterior of the apparatus can be prevented.

Further, it is desirable that the discharge port be formed to be gradually reduced in opening area from an inlet side thereof to an outlet side thereof. More specifically, the upstream side of the discharge port is formed into a rectangle, the opening area thereof is larger than that of the outlet side, and a curvature or an inclination angle of the discharge port is gradually increased toward the outlet side. As a result, the printed sheet is facilitated to enter the discharge port even when the outlet is not in a linear shape, and the resistance in transfer can be decreased in accordance with the gradual deformation. Further, the curl generated on the roll sheet can be corrected.

Still further, it is desirable that the discharge port be provided, near an outlet of the discharge port, with a foreign matter intrusion preventing member protruded in the port. As a result, the intrusion of foreign matters other than the card can also be prevented.

The present invention has the following effect: It suffices that the shape of the outlet of the discharge portion is changed, and hence a printer and an issuing apparatus for effectively preventing a user from mistakenly inserting a card into the discharge port of tickets or the like can be realized without increasing the number of components.

### BRIEF DESCRIPTION OF THE DRAWINGS

In the accompanying drawings:

FIG. 1 is a schematic structural view of a preferred example of a printer to which the present invention is applied;

FIGS. 2A-2B are front views each illustrating an example of a shape of an outlet of a discharge port seen from a front thereof;

FIG. 3 is a rear view of a shape of the outlet of the discharge port seen from an inside thereof;

FIG. 4 is a perspective view of an outlet of another embodiment of the present invention;

FIG. 5 is a perspective view of a ticket-vending machine as an example of an issuing apparatus having the printer according to the present invention built-in;

FIG. 6 is a schematic structural view of another preferred example of a printer to which the present invention is applied; and

FIG. 7 is a schematic structural view of still another preferred example of a printer to which the present invention is applied.

### DETAILED DESCRIPTION OF THE PREFERED EMBODIMENT

In the following, a preferred embodiment of the present invention is described with reference to the drawings.

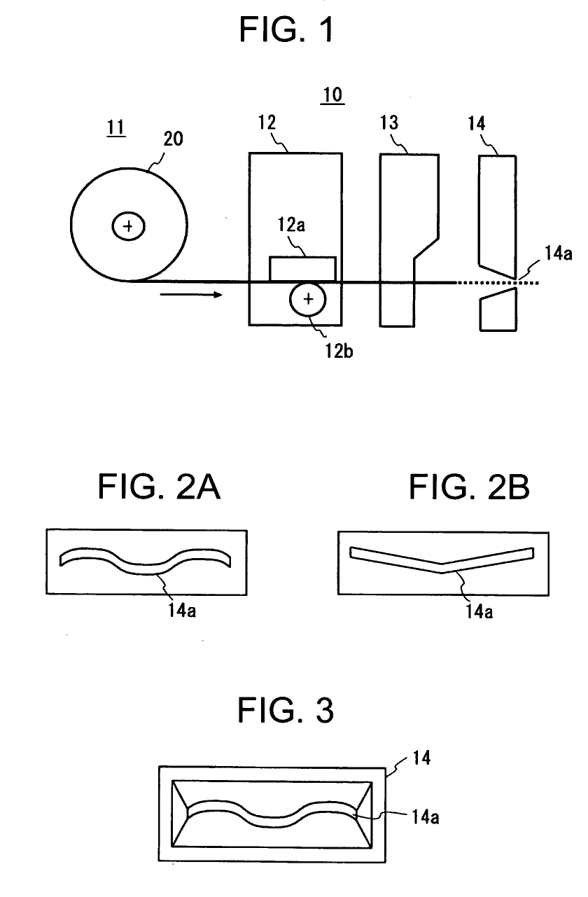

FIG. 1 is a schematic structural view of a preferred example of a printer to which the present invention is applied. A printer 10 illustrated in FIG. 1 includes an accommodating portion 11 for accommodating a roll sheet 20 obtained by winding a recording sheet such as a thermosensitive sheet into a roll shape, a thermal printer unit 12 for printing on the roll sheet drawn out of the accommodating portion 11, a cutter unit 13 for cutting the printed sheet into a piece of sheet of a desired length, a bezel 14 as an outlet constitution member having a discharge port 14a for discharging the cut piece of sheet to the exterior.

The thermal printer unit 12 includes a thermal head 12a formed of a plurality of heating elements arranged in rows, a platen roller 12b disposed such that the outer periphery thereof is brought into contact with the thermal head 12a, and a motor (not shown) for rotatably driving the platen roller 12b, in which the roll sheet is inserted between the thermal head 12a and the platen roller 12b, the platen roller 12b is rotated, and the heating elements of the thermal head are selectively heated while the roll sheet is transferred in the direction of an arrow, whereby printing on the roll sheet is performed.

The cutter unit 13 includes a cutter blade of a rotational type or a sliding type and a motor for rotating or moving the cutter blade, in which cutting of the roll sheet is performed by moving the cutter blade in the direction orthogonal to the transfer direction of the roll sheet.

The bezel 14 has a discharge port 14a which is formed to be larger upstream in opening area, that is, larger on the side facing the cutter unit 13, and to be narrower on the side of the outlet. The bezel 14 is formed of a synthetic resin or the like. The reason the discharge port 14a is formed to be larger upstream in opening area is that the leading end of the roll sheet having been transferred is facilitated to lead toward the relatively narrow outlet.

The present invention focuses on the structure of the bezel 14 as an outlet constitution member. Specifically, the outlet of the discharge port 14a is formed into a corrugated shape as illustrated in FIG. 2A, or a shape other than a linear shape, such as a “dogleg” shape as illustrated in FIG. 2B, when seen from the front thereof, that is, from the side on which a piece of sheet is discharged. Generally, a recording sheet such as a thermosensitive sheet used as a roll sheet is lower in elasticity than a card such as a credit card and a prepaid card. In this context, when the outlet is formed into the corrugated shape or the “dogleg” shape, insertion of the card from the outlet side in the printer direction can be prevented while the recording sheet is easily deformed to pass the outlet.

A curvature along the corrugation of the outlet and a size (numerical value) of an inclination angle for defining a “dogleg” shape are relatively determined in accordance with a height of the outlet (width of slit) and with a thickness and elasticity of a card whose insertion should be prevented. Thus, it is difficult to cite specific numerical values. For example, when the card whose insertion should be prevented is comparatively difficult to bend like a credit card widely used at present, and when the height of the outlet for a piece of printed sheet is the same as the thickness of the card, the insertion of the card can be prevented by forming only a slight corrugated shape.

FIG. 3 illustrates a shape of the discharge port 14a of the bezel 14 seen from the inside thereof, that is, from the cutter side. As illustrated in FIG. 3, in this embodiment, the discharge port is formed into a rectangle in which the upstream side thereof is larger in opening area than the outlet side, and the curvature or the inclination angle is gradually increased toward the outlet side.

When the curvature along the corrugation of the outlet and the inclination angle for defining the “dogleg” shape are acute, the upstream side of the discharge port, that is, the inlet is formed into a rectangle, where by a piece of sheet having entered the discharge port 14a can be gradually deformed in conformity with a shape of the outlet. As a result, the discharge can smoothly progress. That is, when the inlet of the discharge port 14a is formed into the corrugated shape or the “dogleg” shape similarly to the outlet, a piece of sheet sent thereto is flat, and hence the piece of sheet may not smoothly enter the inlet of the discharge port 14a while getting lodged thereto. However, as illustrated in FIG. 3, when the inlet is formed into a rectangle, it is possible to prevent failures in discharge by facilitating the ingress thereof from the inlet and to reduce, when a piece of sheet having high elasticity is used, the resistance upon discharge through gradual deformation of the piece of sheet.

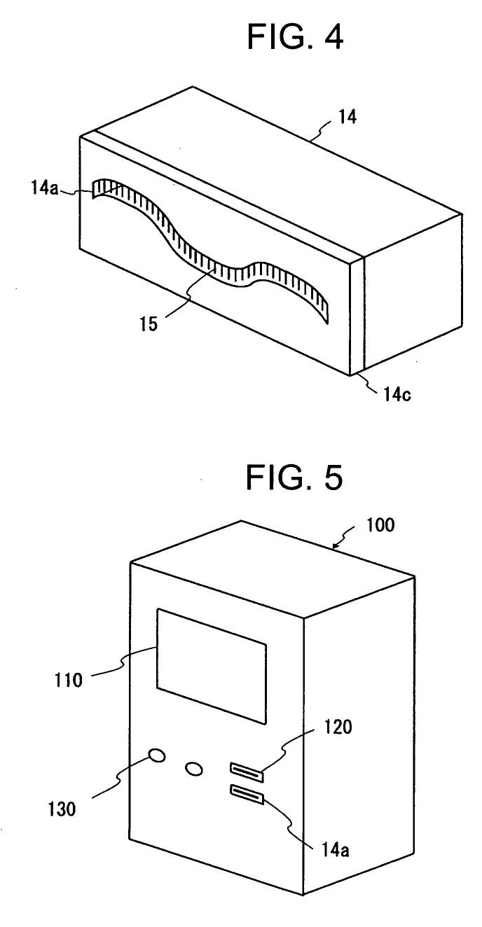

FIG. 4 illustrates another embodiment of the present invention. In this embodiment, the outlet of the discharge port 14a is formed into the corrugated shape or the “dogleg” shape similarly to the first embodiment, and the outlet of the discharge port 14a is provided with a foreign matter intrusion preventing means 15. Specifically, to the front surface of the bezel 14, a front surface plate 14c is bonded which has a corrugated opening portion of the same shape as that of the outlet of the discharge port 14a, and, between the front surface plate 14c and the front surface of the bezel 14, a foreign matter intrusion preventing member 15 of brush-like shape which is suspended toward the opening portion is provided.

The foreign matter intrusion preventing member 15 of brush-like shape may function also as a static electricity removing means for dissipating static electricity charged on a piece of printed sheet by being constituted by a conductive material and grounded. Note that, in that case, the front surface plate 14c and the bezel 14 are formed of a material having insulation properties.

FIG. 5 illustrates a ticket-vending machine as an example of an issuing apparatus having a printer according to the present invention built-in. An issuing apparatus 100 of FIG. 5 has a printer and a card reader built-in, and the front surface thereof is provided with a display portion 110, a card insertion/discharge port 120, the discharge port 14a for discharging tickets printed by the printer described above, operation buttons 130, and the like. Although not apparent from FIG. 5, as described in the embodiment, the outlet of the discharge port 14a is formed into the corrugated shape or the “dogleg” shape. As illustrated in FIG. 5, when the discharge port 14a is provided near the card insertion/discharge port 120, there is a risk that a user mistakenly inserts a card into the discharge port 14a of the tickets. Thus, the present invention is particularly effective when applied to the issuing apparatus as described above.

Note that, it is possible to provide a rectangular opening portion corresponding to the discharge port of the printer of the embodiment on the front surface panel of the issuing apparatus 100, and it is also possible to mount the printer inside the issuing apparatus such that the opening portion is faced with the front surface of the discharge port (bezel) of the printer. Further, it is possible to form an outlet having a shape other than a linear shape, such as a corrugated shape, on the front surface of the issuing apparatus 100.

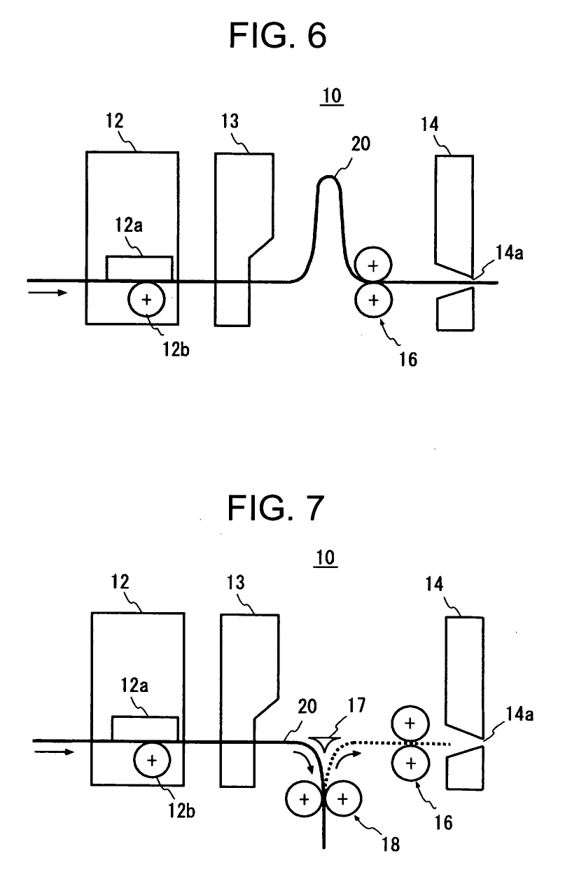

FIGS. 6 and 7 each illustrate another structural example of the printer to which the present invention is applicable. In order to prevent fine printing from being obstructed by a user trying to draw out the roll sheet by forcibly pulling, when the leading end of the roll sheet is protruded from the discharge port before completion of printing, each printer of FIGS. 6 and 7 is provided with a mechanism (referred to as presenter mechanism in this specification) for temporarily stocking printed sheets inside the printer.

Of those, in FIG. 6, send-out rollers 16 are provided between the cutter unit 13 and the bezel 14, and the space portion for allowing a deflection of the roll sheet is provided between a printer unit 12 and the cutter unit 13. Until completion of printing, the rotation of the rollers is stopped in the state where the leading end of the roll sheet is sandwiched between the send-out rollers 16, and the send-out rollers 16 are rotated after finish of printing, whereby the sheet in a deflected state is discharged from the discharge port 14a.

Further, in FIG. 7, a direction conversion means 17 and the send-out rollers 16 are provided between the cutter unit 13 and the bezel 14, and forward/reverse auxiliary rollers 18 are provided below the direction conversion means 17. Until completion of printing, the roll sheet is sent downward once by the auxiliary rollers 18, the send-out rollers 16 are rotated and the auxiliary rollers 18 are reversely rotated after finish of printing, whereby the printed sheet is discharged from the discharge port 14a.

As illustrated in FIGS. 6 and 7, in the printer which has the send-out rollers 16 between the cutter unit 13 and the bezel 14 or on the upstream side of the discharge port 14a, by conforming the shape of the outer peripheral surfaces of the pair of send-out rollers 16 obtained along the axial directions thereof to the shape of the outlet of the discharge port 14a, the sheet to be discharged may be deformed and discharged by the send-out rollers 16. As a result, even when the height of the outlet is small and the curvature or inclination angle of the outlet shape is acute to some extent, the sheet can be easily discharged. Further, as described above, in the case where the outer peripheral shape of the send-out rollers 16 is conformed to the outlet shape, the inlet side of the discharge port 14a may not necessarily be formed to be larger in opening area than the outlet side thereof.

While the inventions made by the inventors of the present invention have been described in detail with reference to the embodiments, it is needless to say that the present invention is not limited to the embodiments, and various modifications can be made without departing from the spirit of the present invention. For example, while the embodiments illustrate the corrugated shape and the “dogleg” shape as examples of the shape of the outlet of the discharge port 14a, the outlet may be formed in S-shape, W-shape, or the like. Further, while the embodiment illustrates the issuing apparatus in which a thermal printer is used as a printing means, the issuing apparatus may be applied to a printer except the thermal printer.

While the above description mainly describes an example in which the inventions made by the inventors of the present invention are applied to the ticket-vending machine which belongs to the application field providing the background thereof, the present invention is not limited thereto, but can be widely used in an ATM (automated teller machine) in the financial institution, a cash register in the store, and the other apparatuses having the printer and the card reader built-in.

What is claimed is:

1. A printer comprising:
an accommodating portion for accommodating a pre-printed sheet;
a printing means for printing on the sheet drawn out of the accommodating portion;
a cutting means for cutting a printed sheet to a desired length; and
a discharge port for discharging a cut sheet to an exterior of an apparatus, wherein an outlet of the discharge port is formed into a shape other than a linear shape when seen from a front thereof.

2. A printer according to claim 1, wherein the discharge port is formed to be gradually reduced in an opening area from an inlet side thereof to an outlet side thereof.

3. A printer according to claim 1, wherein the outlet of the discharge port is formed into a corrugated shape.

4. A printer according to claim 1, wherein the discharge port is provided, near an outlet of the discharge port, with a foreign matter intrusion preventing member protruded in the port.

5. A printer according to claim 1, further comprising, between the cutting means and the discharge port, send-out rollers and a space portion for allowing a deflection of the sheet,
wherein the sheet is deflected while an amount of the sheet conveyed by the send-out rollers is suppressed during printing performed by the printing means; and
after finish of the printing, the cutting means is activated to cut the sheet, and the send-out rollers are activated to discharge the sheet from the discharge port.

6. An issuing apparatus, comprising:
the printer according to claim 1;
a card reader which are built therein;
a front surface panel on which an opening portion corresponding to the discharge port of the printer and a card insertion/discharge port corresponding to the card reader are provided,
wherein the printer is mounted such that the opening portion is faced with a front surface of the discharge port of the printer.
